(19) United States
(12) Patent Application Publication
(10) Pub. No.: US 2024/0261982 A1
(43) Pub. Date: Aug. 8, 2024

(54) DEVICES AND METHODS TO GRIP AN OBJECT

(71) Applicant: Walmart Apollo, LLC, Bentonville, AR (US)

(72) Inventors: Gerald J. Byers, Springfield, MO (US); Tomas A. Blodgett, Fayetteville, AR (US); Shane T. Shelbourn, Pea Ridge, AR (US); Kyle D. Kimpel, Rogers, AR (US)

(21) Appl. No.: 18/431,771

(22) Filed: Feb. 2, 2024

Related U.S. Application Data
(60) Provisional application No. 63/443,319, filed on Feb. 3, 2023.

(51) Int. Cl. B25J 15/00; B25J 15/06; B41K 3/40

(52) U.S. Cl. CPC B25J 15/0071; B25J 15/0616; B41K 3/40

(57) ABSTRACT

In some embodiments, devices and methods are provided herein useful to grip, hold, and/or manipulate the objects. In some embodiments, a gripping device may include a coupler configured to physically couple to a device moving member, a movable member having an object-facing surface, a actuator for actuating the movable member between a retracted position and an extended position, and a plurality of pins fixed on the object-facing surface of first movable member, each of the plurality of pins comprising an end configured to penetrate a surface of a gripped object when the movable member is in the extended position.

### CROSS-REFERENCE TO RELATED APPLICATIONS

This application claims the benefit of U.S. Provisional Application No. 63/443,319 filed Feb. 3, 2023, which is incorporated herein by reference in its entirety.

### TECHNICAL FIELD

This invention relates generally to devices to grip an object (e.g., in a commercial product facility).

### BACKGROUND

In a commercial product facility, various shaped and sized objects and goods are handled. Often, these objects and goods should be manipulated and/or transported from one position to another position. In some conventional approaches, objects and goods have been held by human hands to transport and/or manipulate the objects and goods in a commercial product facility.

### BRIEF DESCRIPTION OF DRAWINGS

Disclosed herein are embodiments of systems, apparatuses and methods pertaining to a device, system, and method for gripping objects. This description includes drawings, wherein:

FIG. 1 depicts a device to grip an object in accordance with some embodiments.

FIG. 2 is an exploded view of the device in accordance with some embodiments.

FIG. 3 is a perspective view of a movable member in accordance with some embodiments.

FIG. 4 is an exploded view of the movable member in accordance with some embodiments.

FIG. 5 is a side view of the device in a retracted configuration in accordance with some embodiments.

FIG. 6 is a perspective view of the device in an extended configuration in accordance with some embodiments.

FIG. 7 is a side view of the device in use in accordance with some embodiments.

FIG. 8 is a perspective view of the device in a flat configuration in accordance with some embodiments.

FIG. 9 is a perspective view of the device in a folded configuration in accordance with some embodiments.

FIG. 10 is a perspective view of the device in use in accordance with some embodiments.

FIG. 11 is a bottom perspective view of the device in a retracted configuration in accordance with some embodiments.

FIG. 12 is a bottom perspective view of the device in a partially extended configuration in accordance with some embodiments.

FIG. 13 is a bottom perspective view of the device in a fully extended configuration in accordance with some embodiments.

FIG. 14 is a top perspective view of the device in accordance with some embodiments.

FIG. 15 is a bottom perspective view of the device in accordance with some embodiments.

FIG. 16 is a side view of the device in a retracted configuration in accordance with some embodiments.

FIG. 17 is a side view of the device in an extended configuration in accordance with some embodiments.

FIG. 18 is a perspective view of the device coupled to a robotic arm in accordance with some embodiments.

FIG. 19 is a top perspective view of the device coupled to the robotic arm in accordance with some embodiments.

FIG. 20 is a bottom perspective view of device coupled to the robotic arm in an extended configuration in accordance with some embodiments.

FIG. 21 is a block diagram of a system for gripping an object in accordance with some embodiments.

FIG. 22 is a flowchart depicting an example method to grip an object in accordance with the embodiments described above.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to grip an object (e.g., in a commercial product facility). In some embodiments, a gripping device comprises a robotic arm end coupler configured to physically couple to a robotic arm, a first movable member having a first object-facing surface, a first actuator for actuating the first movable member between a retracted position and an extended position, and a first plurality of pins fixed on the first object-facing surface of the first movable member, each of the first plurality of pins comprising an end configured to penetrate a surface of a gripped object when the first movable member is in the extended position.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Many existing end-of-arm tools (“EoATs”) to grip an object in a commercial product facility limit a robot's speed because of the inability to provide an adequate engagement between the EoATs with the object. Further, the existing EoATs also have a limitation in applying to various types of objects in terms of physical characteristics such as material types, mass, center of gravity, and external geometry.

In some embodiments, a device is provided that enables rapid manipulation of objects in a commercial product facility by providing a sturdy engagement between the device and a gripped object by using a plurality of pins. Further, devices according to some embodiments also enable tractive pull manipulation of the objects in a commercial product facility. Furthermore, devices according to some embodiments may be applied in narrow work environments such as an environment where the surface of the object is in very close proximity to ceilings and/or walls.

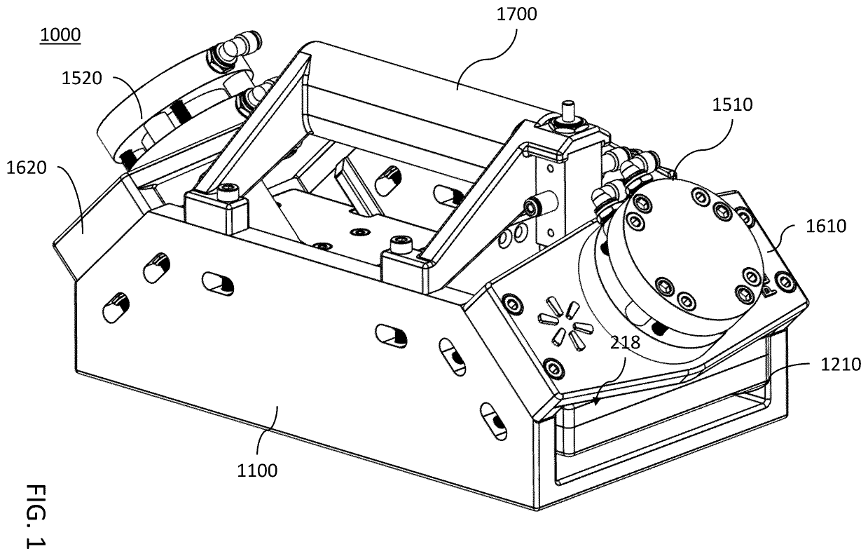

Various embodiments and examples of gripping devices are described herein. Exemplary FIGS. 1-20 are provided to illustrate various embodiments. And it is noted that when describing certain embodiments, certain features may be shown in one or more of FIGS. 1-20.

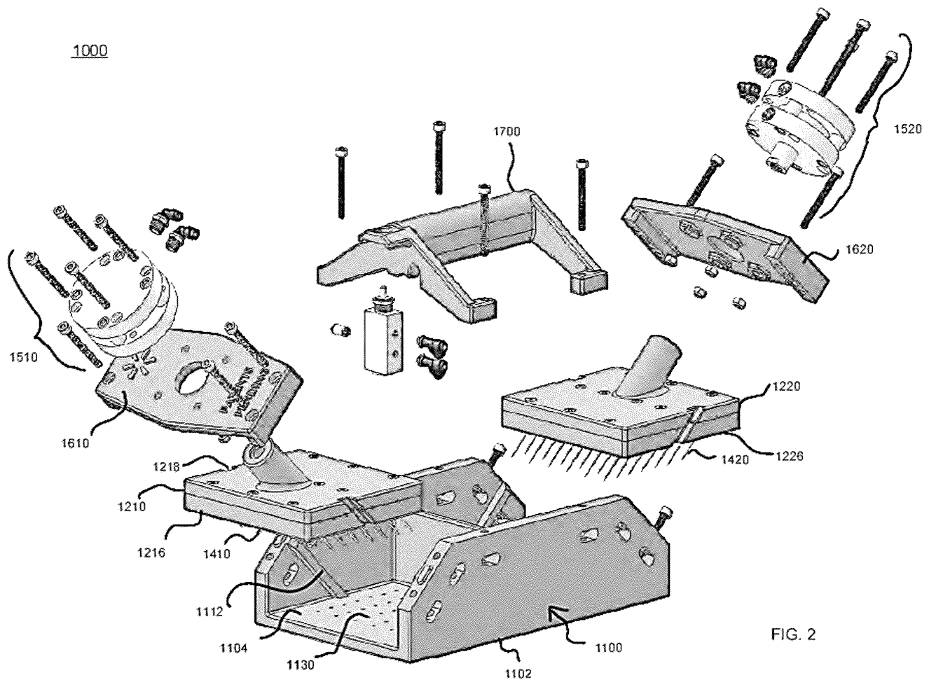

FIG. 1 depicts a device 1000 to grip an object in a commercial product facility in accordance with some embodiments. FIG. 2 is an exploded view of the device 1000 of FIG. 1 in accordance with some embodiments. The device 1000 may be configured to grip an object in a commercial project facility. The commercial product facility may include but is not limited to a store, a distribution center, a warehouse, a fulfillment center of the retailer, or a shopping facility. In some embodiments, the object to be gripped may be but is not limited to a payload, a pallet, a case, a box, a cardboard object, a corrugated cardboard object, a food object, a tote, or other products handled at a commercial project facility. In some embodiments, the object may be made of different materials including paper materials (such as corrugated cardboard), plastic materials, wood materials, a foam material, combinations of the above materials, and so on.

Referring to FIGS. 1 and 2, the device 1000 may include a coupler 1700, a first movable member 1210, a first actuator 1510, and a first plurality of pins 1410.

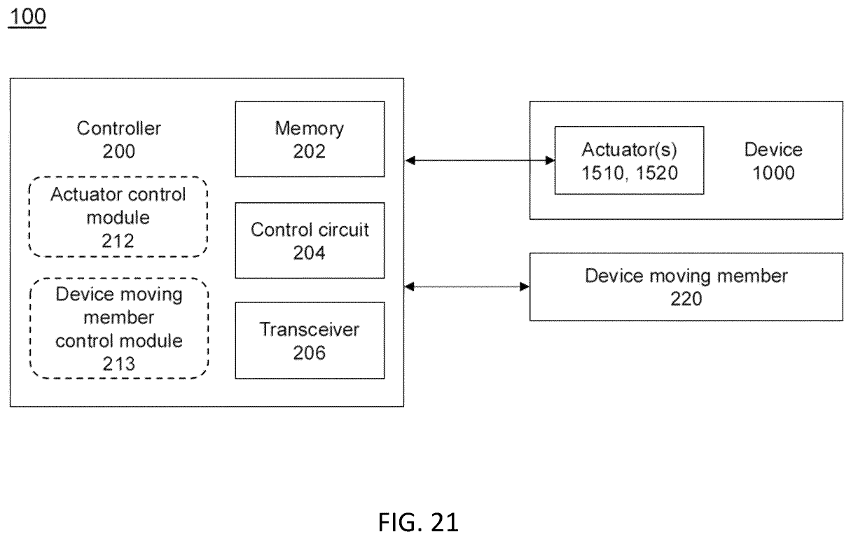

The coupler 1700 may be configured to be physically coupled to a device moving member (e.g., device moving member 220 of FIG. 21). For example, the coupler 1700 may be mechanically or magnetically coupled to the device moving member 220. The shape, structure, and/or feature of the coupler 1700 and coupling method may not be limited to the description herein. Instead, the coupler 1700 may have various shapes, structures, and/or features according to the structure and features of the device moving member 220. In some embodiments, the coupler 1700 may be a robotic arm end coupler.

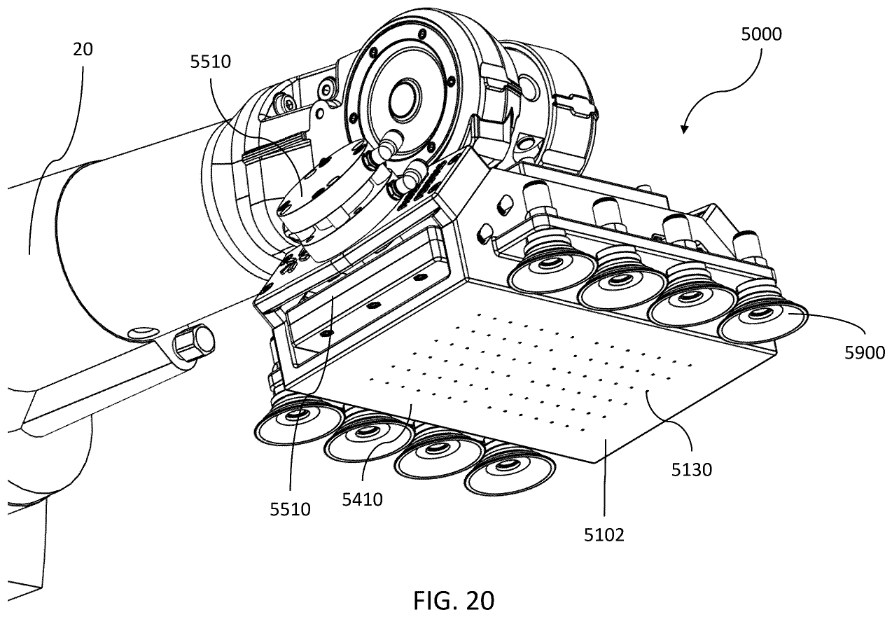

As illustrated in FIGS. 1 and 2, the coupler 1700 may be a handle configured to be held by a device moving member 220. Although the coupler 1700 may be configured to physically couple to the device moving member, the device 1000 may be held by a human (such as a worker) via the coupler 1700, such that the device 1000 may be employed in manual human-in-the-loop environments, in conjunction with a robot system of the commercial product facility. In some embodiments, the device 1000 may be used in conjunction with a lift assist jib, trolley, crane, and/or otherwise automated systems to manipulate various objects in a commercial product facility. In some embodiments, the device moving member 220 may be a robotic arm (e.g., robotic arm 20 of FIG. 20). In some embodiments, the device moving member 220 may be a lift assist jib, trolley, crane, and/or otherwise automated system.

The first actuator 1510 may be connected to the first movable member 1210. The first actuator 1510 may actuate the first movable member 1210 between a retracted position and an extended position. The first movable member 1210 may be disposed closer to the gripped object when the first movable member 1210 is in the extended position than in the retracted position. The first actuator 1510 may be but is not limited to a pneumatic actuator, a mechanical actuator, a hydraulic actuator, an electrical motor, or a magnetic field actuator.

In some embodiments, the device 1000 may further include a body 1100. In some embodiments, the first movable member 1210 may be disposed inside the body 1100 and may be moved between the retracted position and the extended position within the body 1100. In some embodiments, the body 1100 may include a guide rail 1112 and the first movable member 1210 may have a guide slot 1218 configured to engage with the guide rail 1112. The first movable member 1210 may be moved between the retracted position and the extended position along the guide rail 1112. In some embodiments, the body 1100 and the first movable member 1210 may be coupled by a bearing assembly. The bearing assembly may be but is not limited to a rolling bearing such as a ball bearing and roller bearing, or a sleeve bearing.

In some embodiments, the body 1100 may have a gripping surface 1102. The gripping surface 1102 may have a plurality of holes 1130 thereon. In some embodiment, the plurality of holes 1130 may extend from the inner surface 1104 to the gripping surface 1102 of the body 1110. In some configurations, the first plurality of pins 1410 fixed on the first movable member 1210 may pass through the plurality of holes 1130 of the body 1100. In some embodiments, when the device 1000 grips the object, the gripping surface 1102 may contact at least a portion of the gripped object. In one approach, the gripping surface 1102 may be flat (e.g., example, the gripping surface 1102 is in one plane). In other approaches, the gripping surface 1102 may be contour matching a profile of the surface of the gripped object (e.g., the gripping surface 1102 is curved, contoured, shaped, angled to match a corresponding shape of an object to be gripped). In some approaches, the gripping surface 1102 may be a non-rigid or pliable surface that may conform to the profile of the surface of the gripped object, e.g., with the applicable of pressure.

In some embodiments, the device 1000 may further include a supporting panel 1610 to fasten the first actuator 1510 in a fixed position in a relationship with the first movable member 1210. For example, the first actuator 1510 is fixedly attached to the supporting panel 1610 and the supporting panel 1610 is configured to prevent the first actuator 1510 from being moved by the reaction when the first actuator 1510 pushes or pulls the first movable member 1210. In some embodiments, the supporting panel 1610 may be securely fixed to the body 1100.

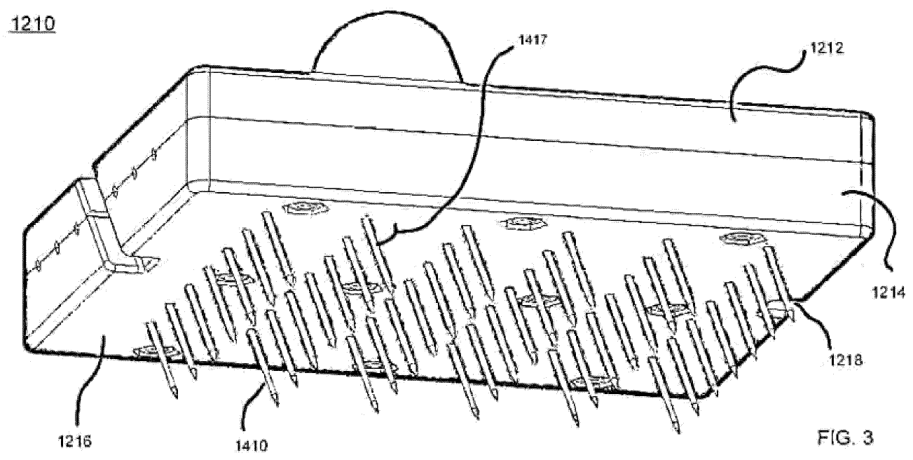

FIG. 3 is an exemplary perspective view of the first movable member 1210 in accordance with some embodiments. Referring to FIG. 3, the first movable member 1210 may have a first object-facing surface 1216. In some embodiments, the first plurality of pins 1410 may be fixed on the first object-facing surface 1216 of the first movable member 1210. The first plurality of pins 1410 fixed on the first object-facing surface 1216 of the first movable member 1210 moves along with the movement of the first movable member 1210. In some embodiments, the first plurality of pins 1410 fixed on the first object-facing surface 1216 may be arranged to have a plurality of rows and columns.

Each of the first plurality of pins 1410 may have an end configured to penetrate the surface of the gripped object. For example, the pins may penetrate at least a portion of the surface of the gripped object with the end when the first movable member 1210 is in the extended position. In some approaches, each end of the first plurality of pins 1410 may be a pointed tip to penetrate at least a portion of the surface of the gripped object 10. In some embodiments, the object 10 may be gripped by the device 1000 via the engagement of the object 10 and the first plurality of pins 1410 penetrated thereto.

In some embodiments, the first plurality of pins 1410 may protrude from the gripping surface 1102 of the body 1110 in a pre-determined length between 0.1 mm and 25 mm when the first movable member 1210 is in the extended position. The pre-determined length of the protrusion of the first plurality of pins 1410 from the gripping surface may be pre-determined based on the profile of the gripped object.

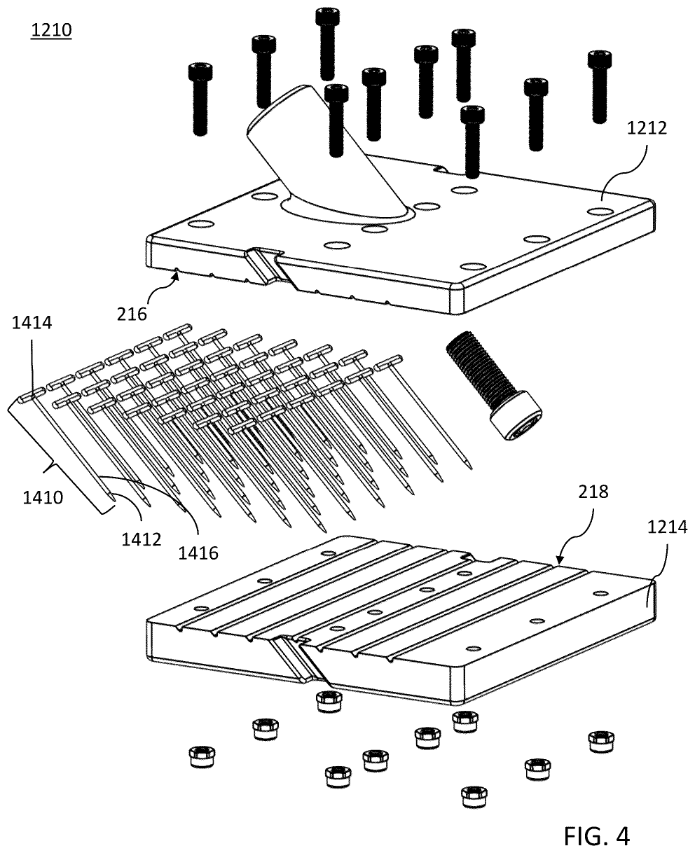

FIG. 4 is an exploded view of the first movable member 1210 in accordance with some embodiments. FIG. 4 illustrates one approach to fix the first plurality of pins 1410 to the first movable member 1210. In some embodiments, each of the first plurality of pins 1410 may have an elongated portion 1416 and a leading portion 1412 extending from the elongated portion 1416. The elongated portion 1416 may be a portion having a substantially constant width or a constant diameter. The leading portion 1412 may be a portion near the end of the pin having a decreasing width or a decreasing diameter. By having a decreasing width or a decreasing diameter, the leading portion 1412 may have a sloped side surface. The leading portion may have a maximum width or a maximum diameter at the boundary between the leading portion 1412 and the elongated portion 1416.

In some embodiments, the diameter or width of the elongated portion 1416 of the first plurality of pins may be 0.1 mm to 12.5 mm. In some embodiments, the diameter or width of the elongated portion 1416 of the first plurality of pins may be 1 mm to 5 mm. In some embodiments, the leading portion 1412 may be tapered from the boundary of the elongated portion to the pointed tip thereof. In some embodiments, the leading portion 1412 may have a generally cone shape such that the leading portion 1412 may have a pointed top at the center thereof. In some embodiments, the leading portion may be tapered from the boundary of the elongated portion to the centered pointed tip. For example, the leading portion 1412 may have a circular cone shape. In some embodiments, the pointed tip of the leading portion may be formed at the edge of the leading portion 1412 and the leading portion may be gradually tapered from the edged pointed tip to the elongated portion. For example, the leading portion 1412 may have a shape similar to a traditional hypodermic needle. In some approaches, the maximum diameter of the leading portion 1412 (i.e., the diameter of the leading portion at the boundary between the elongated portion) may be smaller than the length of the leading portion 1412. This shape of leading portion 1412 of the pin may facilitate penetrating the surface of a gripped object and may reduce the damage of the surface of the gripped object caused by penetration of pins thereto. The leading portion may be tapered at 1 to 90 degrees. When the leading portion is tapered at 90 degrees, the end of the leading portion may be flat. In some embodiments, the leading portion may be tapered at 1 to 89 degrees. In some embodiments, the leading portion may be taped from the boundary of the elongated portion to the pointed top in a gradually increasing tapering degree. For example, the tapering degree may be gradually changed from 0 degrees (at the boundary with the elongated portion) to 1 to 89 degrees (at the end of the leading portion). In some embodiments, each of the first plurality of pins may be a solid pin. In other embodiments, each of the first plurality of pins may be a hollow pin. For example, the inside of the first plurality of pins may be hollowed or empty. In some embodiments, the hollow may open through the end of the leading portion.

In some embodiments, each of the first plurality of pins 1410 may include a wide head 1414 disposed on the opposite side of the leading portion 1412. The wide head 1414 may be wider than the remaining portion of the pins. In some embodiments, each of the first plurality of pins may have a generally T-shape.

In some embodiments, the first movable member 1210 may include two plates, i.e., an upper plate 1212 and a lower plate 1214. The lower plate 1214 may be coupled to the upper plate 1212. In some embodiments, at least one of the upper plate 1212 and the lower plate 1214 may have one or more grooves 216, 218 to dispose the wide head of the first plurality of pins 1410. The grooves 216, 218 may be disposed at least one of the lower surface of the upper plate 1212 and the upper surface of the lower plate 1214. The lower surface of the upper plate 1212 and the upper surface of the lower plate 1214 may be facing one another.

In some embodiments, the lower plate 1214 may have a plurality of holes extending from the upper surface to the lower surface of the lower plate. The lower surface of the lower plate may be the object-facing surface 1216. In some embodiments, the holes may extend from the grooves 218 on the upper surface of the lower plate 1214 to the lower surface of the lower plate 1214.

In some embodiments, the wide head 1414 of each of the first plurality of pins 1410 may be disposed on the groove(s) 216, 218. In some embodiments, at least a portion of the elongated portion 1416 of the pins may be disposed in the holes and the remaining portion of the elongated portion 1416 and the leading portion 1412 of the pins may be protruded from the lower surface (object-facing surface 1216) of the lower plate 1214. When the pins are fixed to the first movable member in this manner, the first plurality of pins may be replaced without replacing the entire first movable member 1210. Further, according to these embodiments, when some of the first plurality of pins 1410 are damaged, non-damaged pins may keep being used by replacing only the damaged pins.

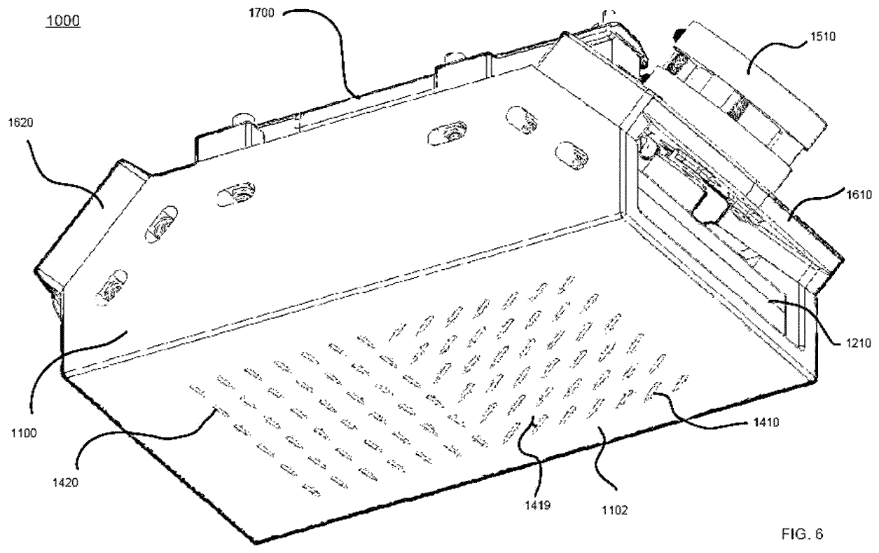

In some embodiments, the first plurality of pins 1410 may be perpendicular to the first object-facing surface 1216. In some embodiments, the first plurality of pins 1410 may be tilted or angled relative to the first object-facing surface 1216 such that the first plurality of pins 1410 may not be perpendicular to the first object-facing surface 1216. This tilted configuration may allow the first plurality of pins 1410 to penetrate the surface of the gripped object in a tilted or angled direction (i.e., not a perpendicular direction) to the surface of the gripped object. The tilted penetration of the first plurality of pins 1410 may reduce or prevent inadvertent removal or separation of the gripped object from the device 1000 when the object is gripped by the device 1000. In some approaches, an angle 1417 (indicated in FIG. 3) between the first plurality of pins 1410 and the first object-facing surface 1216 may be 5 to 90 degrees. When the angle 1417 is 90 degrees, the first plurality of pins may be perpendicular to the first object-facing surface 1216. In some embodiments, when the first plurality of pins 1410 protrudes from the gripping surface, an angle 1419 (indicated in FIG. 6) between the first plurality of pins 1410 and the gripping surface 1102 of the body 1110 may be 5 to 90 degrees.

Referring back to FIGS. 1 and 2, in some embodiments, the device 1000 may further include a second movable member 1220 having a second object-facing surface 1226 and a second plurality of pins 1420 fixed on the second object-facing surface 1226 of the second movable member 1220. In some embodiments, the device 1000 may include more than two movable members. For example, in addition to the second movable member 1220, the device 1000 may further include a third, fourth, fifth, and/or sixth movable member. The second movable member 1220 and the second plurality of pins 1420 may have the same or similar features and/or structures to the first movable member 1210 and the first plurality of pins 1410. For example, each of the second plurality of pins 1420 comprises an end configured to penetrate the surface of the gripped object when the second movable member 1220 is extended. In some embodiments, the device 1000 may further include a second actuator 1520 to actuate the second movable member 1220 between a retracted position and an extended position. The first movable member 1210 may be disposed on one side of the body 1100 and the second movable member 1220 may be disposed on the other side of the body 1100. The third, fourth, fifth, and/or sixth movable member may also have the same or similar features and/or structures to the first movable member.

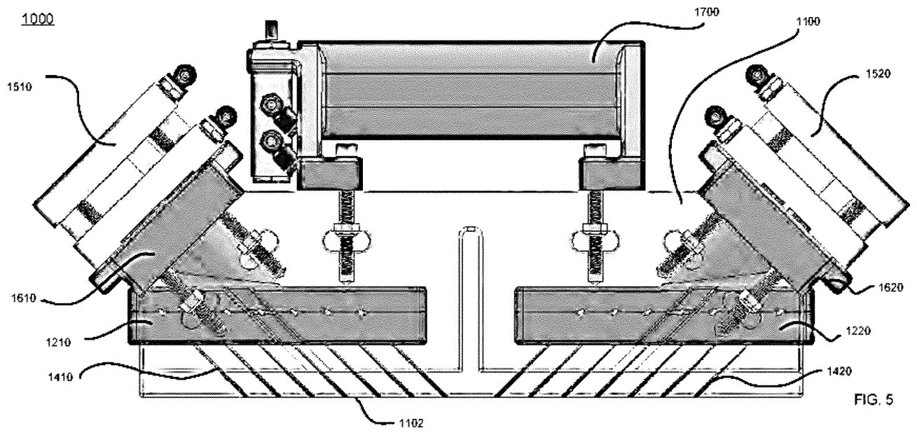

FIG. 5 is a side view of the device 1000 in a retracted configuration illustrating the body 1100 in accordance with some embodiments. When the first and second movable members 1210, 1220 are in the retracted position, the first and second plurality of pins 1410, 1420 may not protrude from the gripping surface 1102 of the body 1100. Each end of pins 1410, 1420 may be disposed at or behind the gripping surface 1102 of the body 1100.

FIG. 6 is a perspective view of the device 1000 in an extended configuration in accordance with some embodiments. When the first and second movable members 1210, 1220 are in the extended position, the first plurality of pins and second plurality of pins 1410, 1420 may protrude from the gripping surface 1102 of the body 1100. In some embodiments, the first plurality of pins 1410 and the second plurality of pins 1420 may protrude from the gripping surface 1102 in different directions or angles relative to each other.

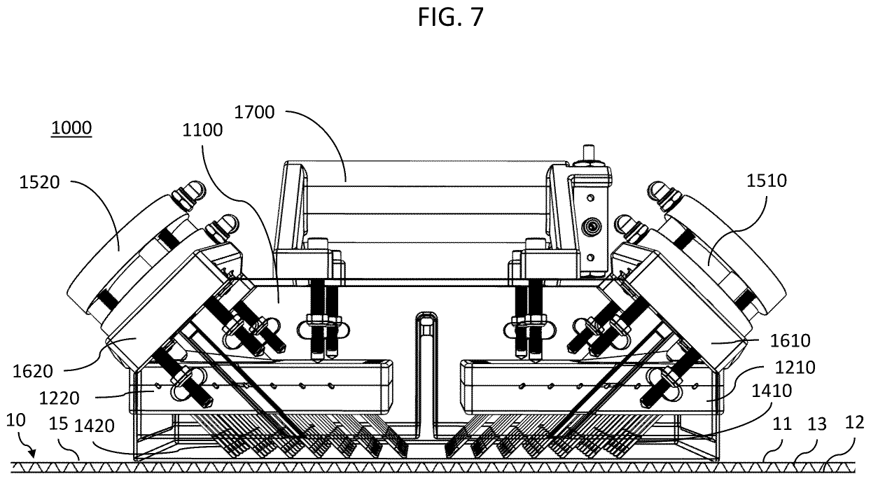

FIG. 7 is a side view of the device 1000 in the retracted configuration in use illustrating the body 1100 in accordance with some embodiments. In some embodiments, the first plurality of pins 1410 and the second plurality of pins 1420 are configured to penetrate the gripped object 10 in different directions and/or from different angles (e.g., the first plurality of pins 1410 may penetrate the object 10 in a direction corresponding to an angle between the first plurality of pins 1410 and the surface of the object 10 and the second plurality of pins may penetrated the object 10 in a direction corresponding to an angle between the second plurality of pins and the surface of the object 10 which is different from the angle between the first plurality of pins and the surface of the object 10). Penetrating the gripped object 10 in different directions may be advantageous because an external force applied in a random direction may allow at least one of the first plurality of pins 1410 and the second plurality of pins 1420 to form a sturdier engagement with the surface of the gripped object. Further, penetrating the gripped object 10 in different directions may reduce or prevent inadvertent removal or separation of the gripped object 10 from the device 1000.

FIG. 7 also illustrates a portion of the gripped object 10. In some embodiments, the gripped object 10 may include corrugated cardboard 15 at the outmost side thereof. In some embodiments, the gripped object may be a corrugated cardboard 15. The corrugated cardboard 15 may refer to cardboard with a layer of wavy fiber on a sheet or between sheets. In these embodiments, each of the first plurality of pins 1410 may be configured to penetrate the corrugated cardboard 15 when the first movable member 1210 is in the extended position. In the embodiment of FIG. 7, the gripped object 10 is a corrugated cardboard 15 having an outer sheet 11, an inner sheet 12 facing the outer sheet 11, and a wavy fiber 13 between the outer sheet 11 and the inner sheet 12. In some approaches, the gripped object 10 may be a corrugated cardboard box housing content therewithin. In some embodiments, when the first and second movable members 1210, 1220 are in the extended position, each end of the first plurality of pins 1410 and second plurality of pins 1420 may penetrate the outer sheet 11 and the wavy fiber 13. In some embodiments, as mentioned, the first plurality of pins 1410 and the second plurality of pins 1420 may protrude from the gripping surface 1102 of the body 1100 in a pre-determined length. In some embodiments, the pre-determined length may be determined based on the profile of the gripped object 10 that is intended to be gripped. For example, the pre-determined length may be determined based on the thickness of the corrugated cardboard 15. In some embodiments, the pre-determined length may be a length that allows the first plurality of pins 1410 and the second plurality of pins 1420 to penetrate the outer sheet 11 and the wavy fiber 13 but not to penetrate the inner sheet 12 of the corrugated cardboard 15.

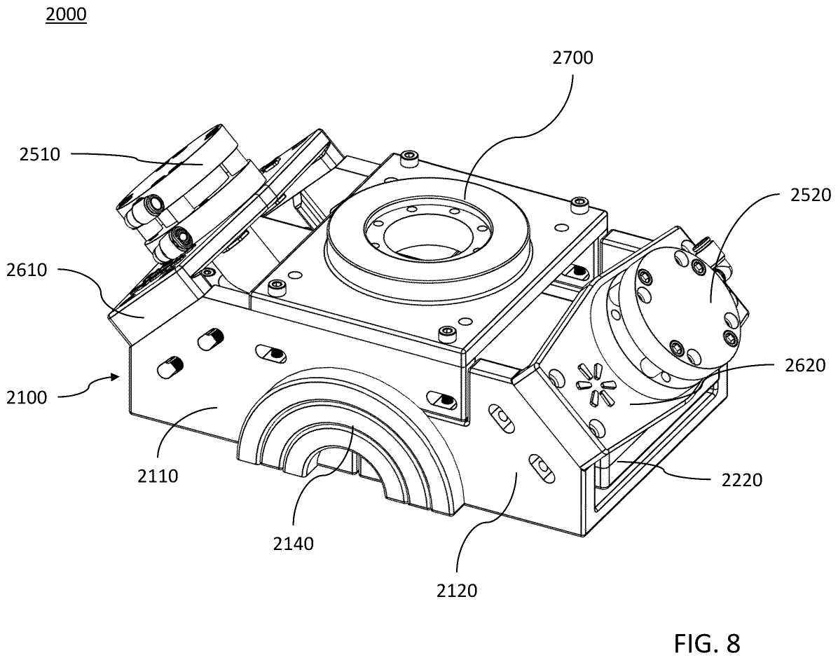

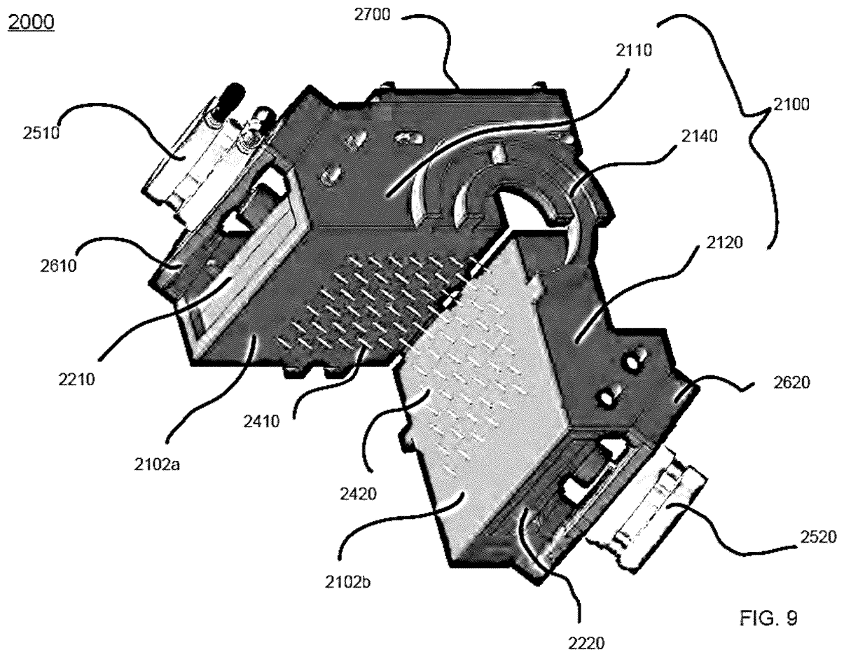

FIGS. 8-10 illustrate another embodiment of a device 2000 in accordance with some embodiments. FIG. 8 is a perspective view of the device 2000 in a flat configuration in accordance with some embodiments. FIG. 9 is a perspective view of device 2000 in a folded configuration in accordance with some embodiments.

For conciseness and clarity, the reference numerals used for features of the device of the embodiments described above that correspond to similar features of the device 2000 of the current embodiment will be used with a prefix “2” instead of the prefix 1 used in FIG. 1-7. For example, an element of the device referenced by the reference numeral “1510” will be shown with the reference numeral “2510” with regard to the device 2000. The device 2000 may be incorporated into any features of the device of the previously described embodiments (for example, the device 1000) unless described otherwise. This rule may also apply to other embodiments (e.g., the device 3000, the device 4000, and the device 5000) described hereafter.

As shown in FIG. 8, in some embodiments, a coupler 2700 of the device 2000 may have a different shape from the coupler 1700 of the embodiment of FIGS. 1-7. For example, the coupler 2700 may include a round ridge and an opening within the round ridge to facilitate coupling with the end of the robotic arm.

Referring to FIGS. 8-10, in some embodiments, a first movable member 2210 and a second movable member 2220 may be coupled via a hinge 2140 and an angle between the first movable member 2210 and the second movable member 2220 is adjustable via the hinge 2140. For example, a body 2100 of the device 2000 may include a first housing 2110 and second housing 2120. The first housing 2110 and the second housing 2120 may connect with one another via the hinge 2140 such that the first housing 2110 and the second housing 2120 may pivot about the hinge relative to one another. In some embodiments, a first movable member 2210 may be disposed in the first housing 2110 and a second movable member 2220 may be disposed in the second housing 2120. In these embodiments, the first movable member 2210 and the second movable member 2220 may be coupled to the hinge 2140 via the first and second housings 2110, 2120 such that an angle between the first movable member 2210 and the second movable member 2220 may be adjusted by pivoting the first housing 2110 and/or the second housing 2120 about the hinge 2140 as shown in FIG. 9.

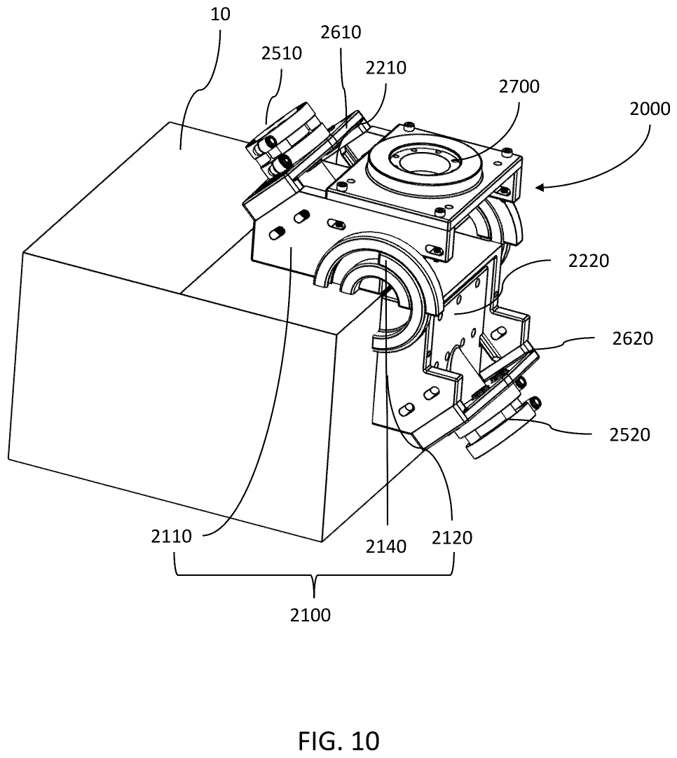

FIG. 10 is a perspective view of the device 2000 in use in accordance with some embodiments. As illustrated in FIG. 10, the first housing 2110 and/or the second housing 2120 may rotate according to the profile of the gripped object 10. In some embodiments, the gripping surface 2102a of the first housing 2110 may contact one surface of the gripped object 10 and the gripping surface 2102b of the second housing 2120 may contact the other surface of the gripped object 10. By gripping the object 10 from the two different surfaces, the device 1000 may grip the object 10 more firmly.

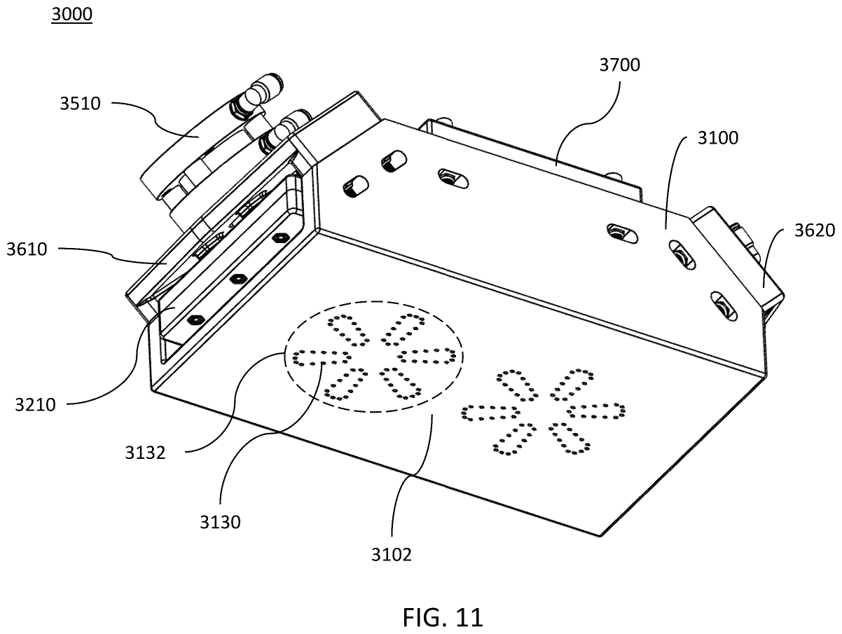

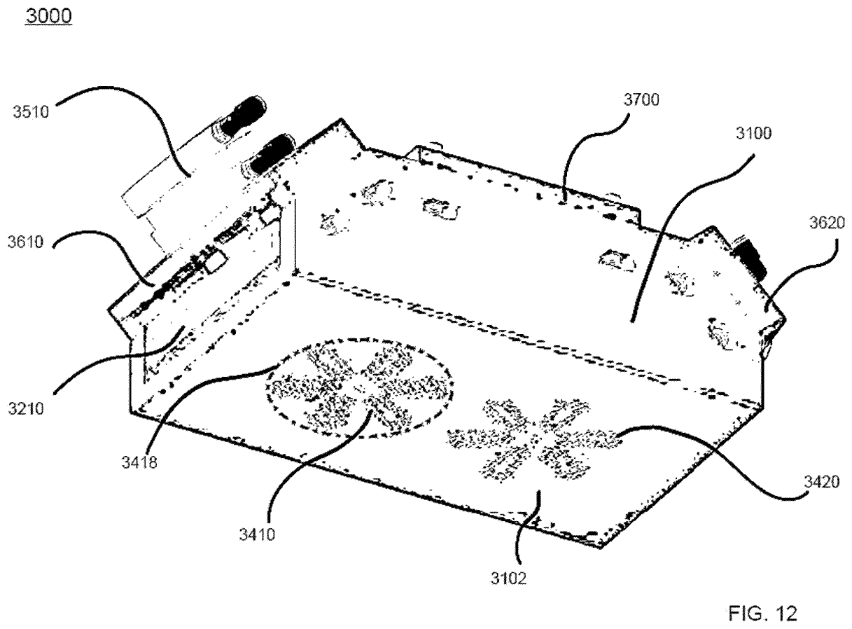

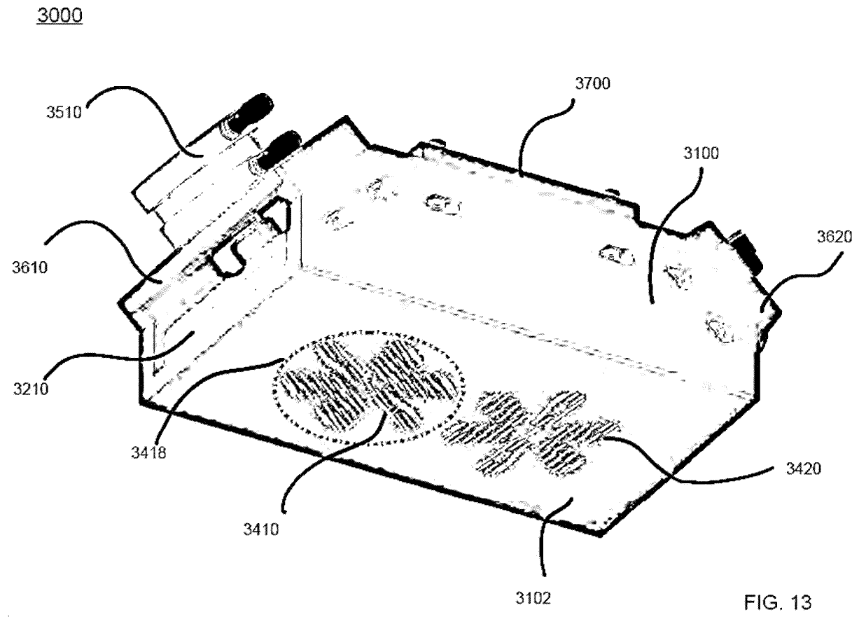

FIGS. 11-13 illustrate another embodiment of a device 3000 in accordance with some embodiments. FIG. 11 is a bottom perspective view of the device 3000 in a retracted configuration in accordance with some embodiments. FIG. 12 is a bottom perspective view of device 3000 in a partially extended configuration in accordance with some embodiments. FIG. 13 is a bottom perspective view of device 3000 in a fully extended configuration in accordance with some embodiments.

Referring to FIGS. 11-13, in some embodiments, at least one of the first plurality of pins 3410 and the second plurality of pins 3420 is deployed in a pattern representing an image, a logo, a text, and/or identifiable information. Further, a plurality of holes 3130 on the gripping surface 3102 of the body 3100 may be disposed in a pattern corresponding to the patterns of the first plurality of pins 3410 and the second plurality of pins 3420. For example, the pattern may represent WALMART's spark logo as illustrated in portion 3418 in FIGS. 11-13. In the embodiments where at least one of the first plurality of pins 3410 and the second plurality of pins 3420 is deployed in a pattern representing the image, logo, text, and/or identifiable information, at least one of the first plurality of pins 3410 and the second plurality of pins 3420 may engrave or carve the image, logo, text, and/or identifiable information represented by the pattern on the surface of the gripped object 10. In some embodiments, it is intended the pattern remain visible on the surface of the object when the object is no longer being gripped. That is, it will be clear that the robotic device gripped a particular object based on the remaining image applied to the object. In some embodiments, the pattern may be indicative that a given object passed a certain portion in the handling of the object.

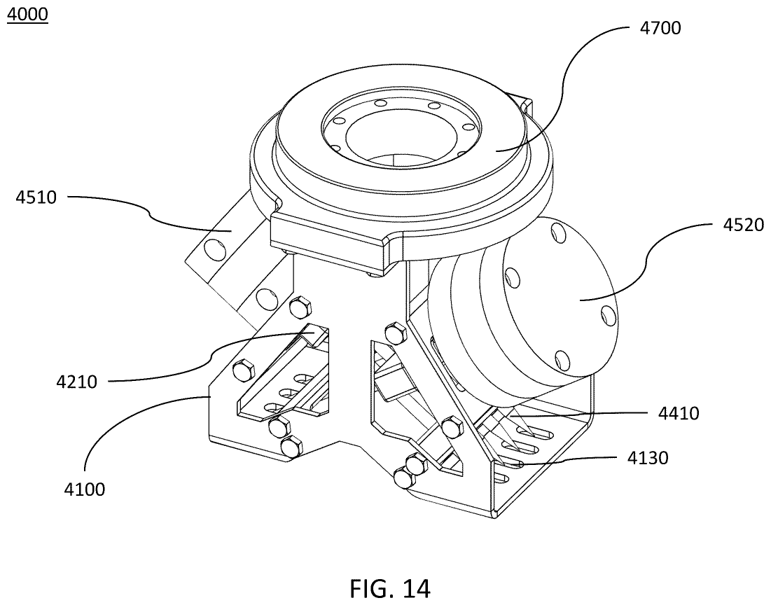

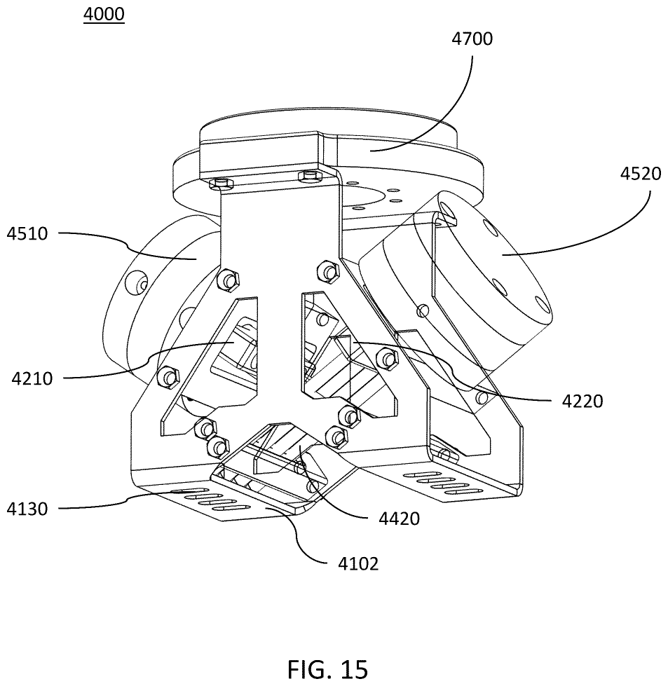

FIGS. 14-17 illustrate another embodiment of a device 4000 in accordance with some embodiments. FIG. 14 is a top perspective view of the device 4000 in a retracted configuration in accordance with some embodiments. FIG. 15 is a bottom perspective view of device 4000 of FIG. 14.

As illustrated in FIGS. 14-15, in some embodiments, each of the first plurality of pins 4410 and the second plurality of pins 4420 may be arranged to have a single row. Specifically, the first plurality of pins 4410 fixed to a first movable member 4210 may be arranged in a single row. Similarly, the second plurality of pins 4420 fixed to a second movable member 4220 may be arranged in a single row. In some embodiments, the first plurality of pins 4410 and the second plurality of pins 4420 may be arranged to cross each other. For example, each pin of the first plurality of pins 4410 may cross each pin of the second plurality of pins 4420.

While the body 1100, 2100, 3100 of the previous embodiments of FIGS. 1-13 generally covers or houses the first and second movable members including the first plurality of pins and the second plurality of pins when the first plurality of pins and the second plurality of pins are in the retracted position, the body 4100 of the embodiment of FIG. 14 may have a frame structure configured to expose the first and second movable members 4210, 4220 and the first plurality of pins 4410 and the second plurality of pins 4420 even when the first plurality of pins 4410 and the second plurality of pins 4420 are in the retracted position.

In some embodiments, the device 4000 of the embodiment of FIG. 14 may be used to grip foods in commercial product facilities. The frame structure of the body 4100 and/or a single-row array of the pins 4410, 4420 may facilitate washing pins 4410, 4420 after gripping objects such as foods and may allow the device to be kept clean.

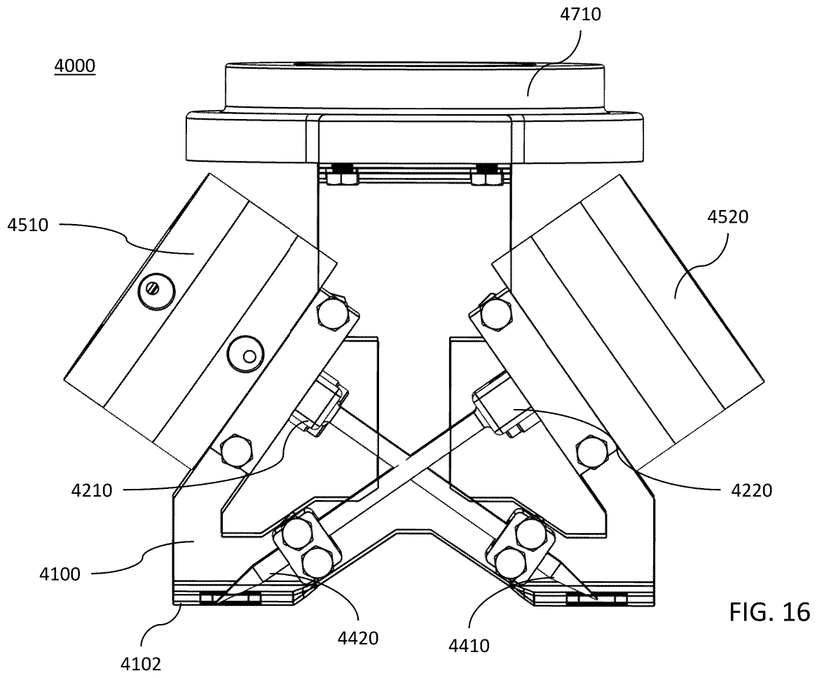

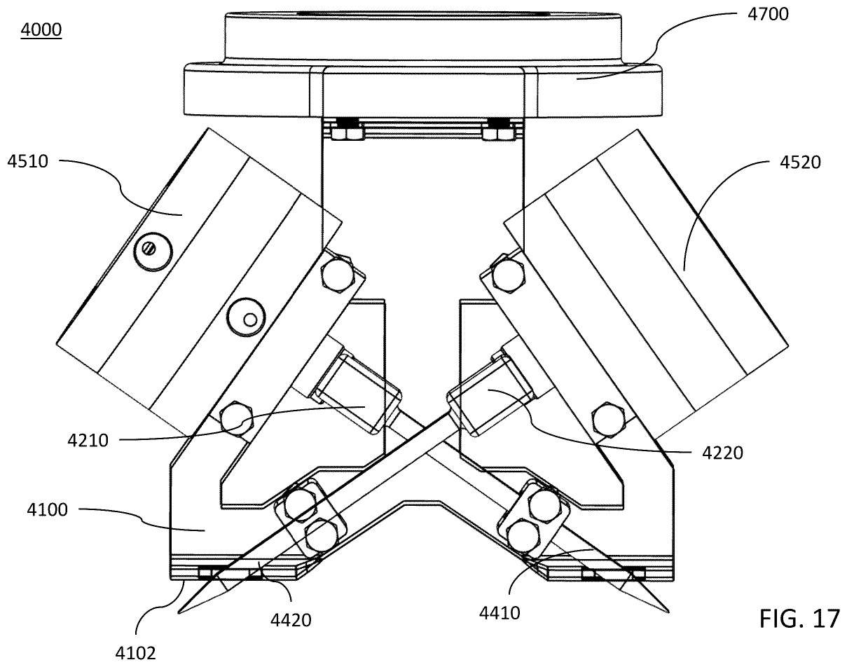

FIG. 16 is a side view of the device 4000 in the retracted configuration illustrating the body 4100 in accordance with some embodiments. FIG. 17 is a side view of the device 4000 in the extended configuration illustrating the body 4100 in accordance with some embodiments. When the first and second movable members 4210, 4220 are in the retracted position as shown in FIG. 16, the ends of the first plurality of pins 4410 and the second plurality of pins 4420 may not protrude from the gripping surface 4102 of the body 4100. When the first and second movable members 4210, 4220 are in the extended position as shown in FIG. 17, the ends of the first plurality of pins and the second plurality of pins may protrude from the gripping surface 4102 of the body 4100.

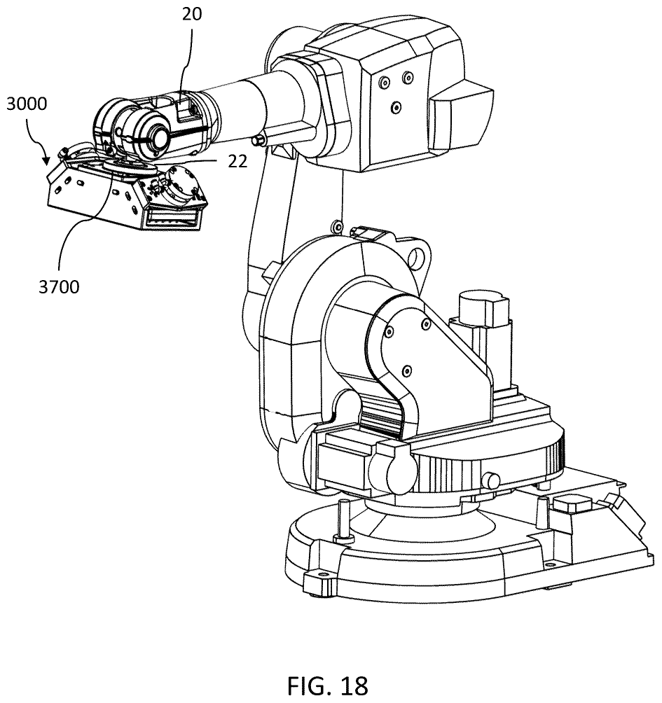

FIG. 18 is a perspective view of the device 3000 coupled to the robotic arm 20. In some embodiments, the device 3000 may be physically coupled to the end of the robotic arm 20 via the coupler 3700 such that the device 3000 may be moved by the robotic arm 20. The robotic arm 20 may move the device 3000 from one position to the other position. The robotic arm 20 may rotate the device 3000 such that the orientation of the gripping surface 3102 of the device 3000 may be controlled.

In some embodiments, the devices 1000, 2000, 3000, 4000 may be used in conjunction with other gripping methods to enhance the gripping efficacy. For example, the devices 1000, 2000, 3000, 4000 may be used in conjunction with suction cups, foam pads, magnetic elements, sticky or adhesive components, and/or other mechanical grippers.

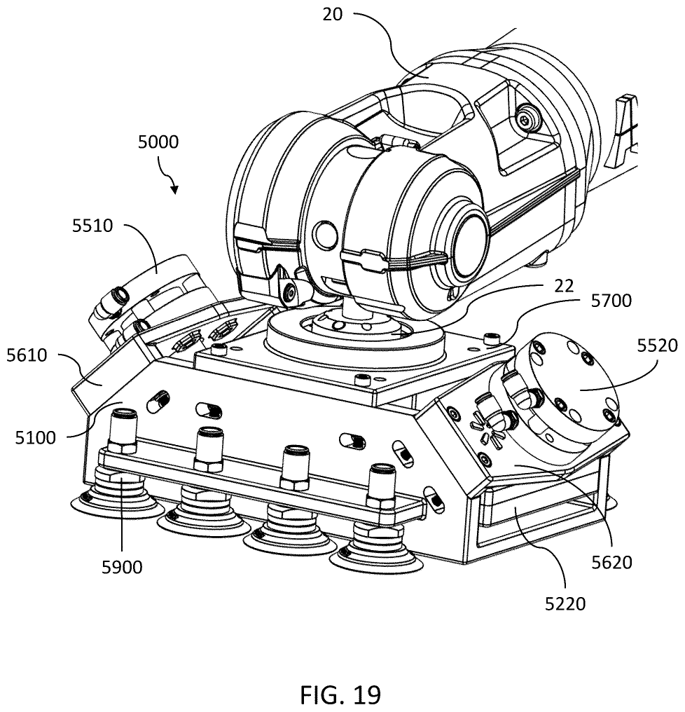

FIGS. 19-20 illustrate another embodiment of a device 5000 coupled to the robotic arm 20 in accordance with some embodiments. FIG. 19 is a top perspective view of the device 5000 in accordance with some embodiments. FIG. 20 is a bottom perspective view of device 5000 in an extended configuration in accordance with some embodiments. In some embodiments, the device 5000 may further include one or more suction cups 5900. In some embodiments, the suction cups 5900 may be disposed on the side of the body 5100. The suction cups 5900 may be configured to apply a vacuum suction force to the gripped object such that the vacuum suction force may enhance the engagement between the device 5000 and the gripped object. For example, in some embodiments, the vacuum suction force may be applied to the direction where the gripping surface 5102 is facing. It is noted that suction cups 5900 may be more generically referred to as suction members including cups and any other known mechanism that can provide a suction force by removing air through an opening. For example, a suction member may be an opening in the gripping surface 5102 or other adjacent surface that contacts the object. In some embodiments, the structure of a suction cup enhances the vacuum force against the object.

FIG. 21 is a block diagram of a system 100 to grip an object in a commercial product facility according to some embodiments. The system 100 may comprise a controller 200, the device 1000 and a device moving member 220. In some embodiments, the device moving member 220 may be the robotic arm 20. In some embodiments, the device moving member 220 may be a lift assist jib, trolley, crane, and/or otherwise automated systems to manipulate various objects in a commercial product facility. The device may be coupled to the device moving member 220 via a coupler 170. In some embodiments, the lift assist jib, trolley and/or crane may be moved by using a manually actuated air valve to engage cylinder driving pins, electric buttons, solenoid, switches, as on. In some embodiments, the controller 200 may comprise a memory 202 and a control circuit 204. By one optional approach, the controller 200 may further comprise a transceiver 206 to communicate with other components of the system 100.

The memory 202 may store data and codes for various control modules to operate the system 100. The memory 202 may comprise but is not limited to non-volatile memory such as read-only memory (ROM) and/or volatile memory such as an erasable programmable read-only memory (EPROM). The control circuit 204 may access the memory 202 and execute the codes for the control modules stored in the memory 202, for example, by using the corresponding programming as will be well understood by those skilled in the art. In some embodiments, the control circuit 204 may be a fixed-purpose hard-wired platform or can comprise a partially or wholly programmable platform or processor, such as a microcontroller, an application specification integrated circuit, a field programmable gate array, and so on. These architectural options are well known and understood in the art and require no further description here.

In some embodiments, control circuit 204 may operably couple to the memory 202. In some embodiments, the memory 202 may be integral to the control circuit 204 or may be physically discrete in whole or in part from the control circuit 204 as desired. This memory 202 may also be local with respect to the control circuit 204 (where, for example, both share a common circuit board, chassis, power supply, and/or housing) or may be partially or wholly remote with respect to the control circuit 204 (where, for example, the memory is physically located in another housing).

In some embodiments, the controller 200 may comprise an actuator control module 212 and a device moving member control module 213. Codes for each of the actuator control module 212 and the device moving member control module 213 may be stored in the memory 202 and executed by the control circuit 204.

In some embodiments, the actuator control module 212 may be configured to control the actuators 1510, 1520 to actuate the first and second movable members 1210, 1220. For example, the actuator control module 212 may control the operation of the actuator 1510, 1520 to move the first and second movable members 1210, 1220 between the retracted position and the extended position.

In some embodiments, the device moving member control module 213 may be configured to control the movement of the device moving member 220. In some embodiments, the device moving member control module 213 may control the movement of the robotic arm 20 including changing the position of the end of the robotic arm and rotating the end of the robotic arm 20.

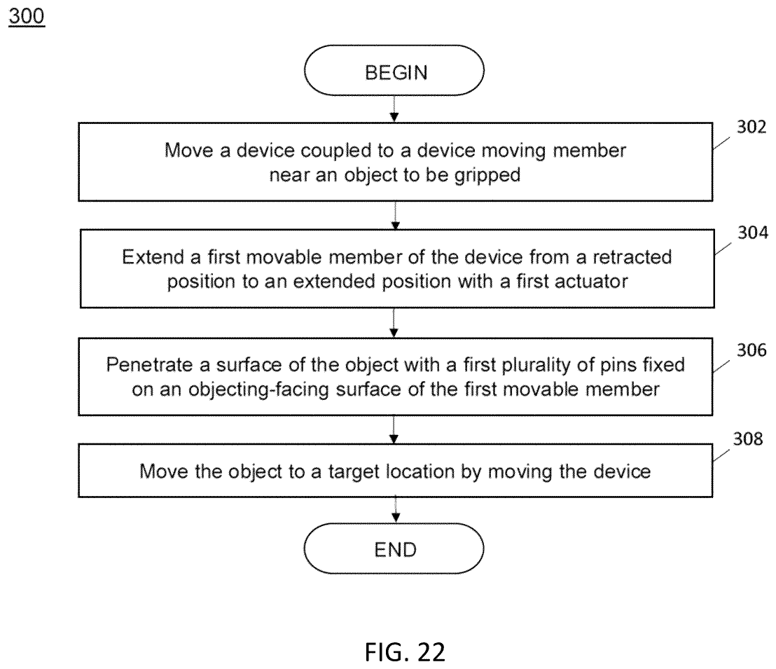

FIG. 22 is a flowchart depicting an example method 300 to grip an object in a commercial product facility that may be performed using a device in accordance with the embodiments described above. For example, the method 300 may be performed using the exemplary devices 1000, 2000, 3000, 4000, 5000 depicted in FIGS. 1-20. Although the method 300 is described herein mainly referring to the device 1000 depicted in FIGS. 1-7, the devices 2000, 3000, 4000, 5000 or other suitable devices may also be used to perform the method 300. The flow begins at block 302.

At block 302, the device 1000 coupled to the device moving member 220 may be moved near the object 10 to be gripped. The device 1000 may be moved by the device moving member 220. In some embodiments, the device 1000 may be coupled to the end 22 of the robotic arm 20 via a coupler 1700 of the device 1000. The device 1000 may be moved by the robotic arm 20. The controller 200 may control the movement of the device moving member 220 to move the device 1000 near the object to be gripped. In some embodiments, the device 1000 may be moved to a gripping location where the first object-facing surface 1216 of the first movable member 1210 and the second object-facing surface 1226 of the second movable member 1220 may be near the surface of the object to be gripped. In some embodiments, at the gripping location, the gripping surface 1102 of the body 1100 may contact the surface of the object 10 to be gripped.

In some embodiments, the method 300 may further include adjusting an angle between the first movable member 1210 and a second movable member 1220. The angle between the first movable member and the second movable member may be adjusted by pivoting at least one of the first movable member and the second movable member around the hinge 2140.

In these embodiments, the first movable member 2210 and the second movable member 2220 may be disposed in the first and second housings 2110, 2120 respectively such that an angle between the first movable member 2210 and the second movable member 2220 may be adjusted by pivoting the first housing 2110 and/or the second housing 2120 about the hinge 2140. In some embodiments, when the device 2000 has been moved to the gripping location, the gripping surface 2102a of the first housing 2110 may contact one surface of the object 10 and the gripping surface 2102b of the second housing 2120 may contact the other surface of the object 10. The first movable member and the second movable member may not be extended before the device has been placed in the gripping location. The flow continues at block 304.

At block 304, the first actuator 1510 may extend the first movable member 1210 from the retracted position to the extended position. In some embodiments, at block 304 the second actuator 1520 may extend the second movable member. The controller 200 may control the actuators 1510, 1520 to extend the first and second movable members 1210, 1220. When the first and second movable members 1210, 1220 are in the retracted position, each end of first plurality of pins 1410 and second plurality of pins 1420 may be behind the gripping surface 1102 of the base of the body 1100 such that may not protrude from the gripping surface 1102 of the body 1100. When the first and second movable members 1210, 1220 are in the extended position, the first plurality of pins 1410 and second plurality of pins 1420 may protrude from the gripping surface 1102 of the body 1100. The first and second movable members 1210, 1220 may be extended in a pre-determined amount. The flow continues at block 306.

At block 306, the first plurality of pins 1410 may penetrate the surface of the object 10. In some embodiments, at block 306, the second plurality of pins 1420 may penetrate the surface of the object 10 which the first plurality of pins 1410 penetrates. In some embodiments, the second plurality of pins 1420 may penetrate a surface different from the surface which the first plurality of pins 1410 penetrates.

In some embodiments, block 306 may be simultaneously performed to block 304. Penetrating the surface of the object with the first plurality of pins 1410 and the second plurality of pins 1420 may simultaneously occur to extend the first movable member 1210 and second movable member 1220 to the extended position. At block 306, the device 1000 may grip the object 10 by penetrating the surface(s) of the object 10 with the first plurality of pins 1410 and/or the second plurality of pins 1420. The engagement between the penetrated pins 1410, 1420 and the object may allow the device 1000 to grip or hold the object 10. As mentioned, the pre-determined amount of extension of the first and second movable members 1210, 1220 may achieve positive engagement without over-penetrating the surface of the object and damaging the contents of the object. In some embodiments, the amount of the extension of the first and second movable members 1210, 1220 may be pre-determined as a range that the first plurality of pins 1410 and second plurality of pins 1420 penetrate the surface of the object 10 in 0.1 mm to 25 mm. In some embodiments, to enhance the engagement between the device 1000 and the gripped object 10, a vacuum suction force on the surface of the gripped object by one or more suction cups 5900 disposed on the body of the device.

In some embodiments, the first plurality of pins 1410 and the second plurality of pins 1420 may be obliquely thrust into the surface of the gripped object 10. This oblique insertion of the first plurality of pins 1410 and the second plurality of pins 1420 may form a sturdier engagement with the gripped object 10 than a perpendicular insertion. In some embodiments, the insertion angle of the first plurality of pins 1410 and the second plurality of pins 1420 to the surface of the gripped object 10 may be 5 to 90 degrees.

In some embodiments, the method 300 may further include engraving an image, a logo, a text, and/or identifiable information on the surface of the gripped object 10. In some embodiments, at least one of the first plurality of pins 3410 and the second plurality of pins 3420 is deployed in a pattern representing the image, logo, text, and/or identifiable information, such that penetrating the surface of the gripped object 10 with the first and second plurality of pins 3410, 3420 may engrave the image, logo, text, and/or identifiable information on the surface of the gripped object 10. The image, logo, text, and/or identifiable information engraved on the surface of the gripped object 10 may be illustrated with a plurality of dots carved on the surface of the gripped object 10. The flow continues at block 308.

At block 308, the gripped object 10 may be moved to a target location. The object 10 has been gripped by the device 1000 at block 306, the gripped object 10 may be moved to a target location by moving the device 1000. The device may be moved by moving the device moving member 220 to which the device is coupled. The flow ends at block 308.

In some embodiments, the method 300 may further comprise retracting the first movable member 1210 and/or the second movable member 1220 from the extended position to the retracted position after moving the gripped object to the target location. In some embodiments, the object gripped by the device may be released by retracting the first movable member 1210 and/or the second movable member 1220 from the extended position to the retracted position. When the additional vacuum suction force is applied at block 306, the applied vacuum suction force may be removed to release the gripped object 10.

In some embodiments, a gripping device comprises a coupler configured to physically couple to a device moving member, a first movable member having a first object-facing surface, a first actuator for actuating the first movable member between a retracted position and an extended position, and a first plurality of pins fixed on the first object-facing surface of the first movable member, each of the first plurality of pins comprising an end configured to penetrate a surface of a gripped object when the first movable member is in the extended position.

In some embodiments, a method to grip an object using a gripping device comprises moving a coupler of the gripping device near the object to be gripped, extending, using a first actuator, a first movable member of the gripping device from a retracted position to an extended position, and penetrating, as the first movable member moves to the extended position, a surface of the object with ends of a first plurality of pins fixed on a first object-facing surface of the first movable member.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A gripping device comprising:
a coupler configured to physically couple to a device moving member;
a first movable member having a first object-facing surface;
a first actuator for actuating the first movable member between a retracted position and an extended position; and
a first plurality of pins fixed on the first object-facing surface of the first movable member, each of the first plurality of pins comprising an end configured to penetrate a surface of a gripped object when the first movable member is in the extended position.

2. The gripping device of claim 1 further comprising a second movable member having a second object-facing surface and a second plurality of pins fixed on the second object-facing surface of the second movable member, each of the second plurality of pins comprising an end configured to penetrate a surface of the gripped object when the second movable member is extended.

3. The gripping device of claim 2 wherein the first movable member and the second movable member are coupled via a hinge, and an angle between the first movable member and the second movable member is adjustable via the hinge.

4. The gripping device of claim 2 wherein the first plurality of pins and the second plurality of pins are configured to penetrate the gripped object in different directions.

5. The gripping device of claim 1 wherein the gripped object is a corrugated cardboard.

6. The gripping device of claim 1 wherein the first plurality of pins is deployed in a pattern representing an image, a logo, a text, and/or identifiable information.

7. The gripping device of claim 1 further comprising one or more suction members configured to apply a vacuum suction force to the gripped object.

8. The gripping device of claim 1 wherein the first movable member comprises an upper plate and a lower plate, the lower plate coupled to the upper plate, at least one of the upper plate and the lower plate having one or more grooves where a wide head of each of the first plurality of pins is deployed.

9. The gripping device of claim 1 wherein the first plurality of pins is tilted relative to a direction not perpendicular to the first object-facing surface of the first movable member.

10. The gripping device of claim 1 wherein each of the first plurality of pins has an elongated portion and a leading portion having a sloped side surface, and wherein a diameter of the elongated portion of each of the first plurality of pins is 0.1 mm to 12.5 mm.

11. The gripping device of claim 1 further comprising a body having a gripping surface with a plurality of holes thereon, and wherein each of the first plurality of pins is configured to pass through a corresponding hole of the plurality of holes when the first movable member is in the extended position.

12. The gripping device of claim 11 wherein, in the extended position, the first plurality of pins protrudes from the gripping surface of the body in a pre-determined length between 0.1 mm and 25 mm.

13. The gripping device of claim 1 wherein, each of the first plurality of pins is a hollow pin.

14. A method to grip an object using a gripping device, the method comprising:
moving a coupler of the gripping device near the object to be gripped;
extending, using a first actuator, a first movable member of the gripping device from a retracted position to an extended position; and
penetrating, as the first movable member moves to the extended position, a surface of the object with ends of a first plurality of pins fixed on a first object-facing surface of the first movable member.

15. The method of claim 14 further comprising moving, after penetrating the surface of the gripped object, the object to a target location by moving the gripping device with the coupler.

16. The method of claim 15 further comprising retracting, after moving the object to the target location, the first movable member from the extended position to the retracted position, the gripped object being released by the retracting of the first movable member from the extended position to the retracted position.

17. The method of claim 14 further comprising engraving an image, a logo, a text, and/or identifiable information on the surface of the object with the first plurality of pins.

18. The method of claim 14 further comprising applying a vacuum suction force on the surface of the object with a suction member.

19. The method of claim 14 wherein a step of penetrating the surface of the object comprises obliquely thrusting the first plurality of pins into the surface of the object.

20. The method of claim 14 further comprising adjusting, before a step of extending the first movable member, an angle between the first movable member and a second movable member having a second plurality of pins fixed on a second object-facing surface of the second movable member, wherein the second movable member is connected to the first movable member.
